(19) United States
(12) Patent Application Publication
(10) Pub. No.: US 2017/0161055 A1
(43) Pub. Date: Jun. 8, 2017

(54) CONTROL MODULE AND CONTROL METHOD OF ELECTRONIC DEVICE

(71) Applicant: proeasy network solutions co., LTD., Hsinchu County (TW)

(72) Inventor: Hsing-Hung Lu, Hsinchu County (TW)

(73) Assignee: proeasy network solutions co., LTD., Hsinchu County (TW)

(21) Appl. No.: 15/438,037

(22) Filed: Feb. 21, 2017

Related U.S. Application Data
(63) Continuation-in-part of application No. 14/584,912, filed on Dec. 29, 2014.

(30) Foreign Application Priority Data
Sep. 11, 2014 (TW) 103131330

(51) Int. Cl. G06F 9/445; G05B 19/414

(52) U.S. Cl. CPC G06F 8/65; G05B 19/414; G05B 2219/31103

(57) ABSTRACT

An embodiment of the invention provides a control module of an electronic device. The control module includes a processor, a first button, a second button and a status control switch. The processor is coupled to the first button, the second button and the status control switch. The processor is configured to determine whether a first trigger status of the first button and a second trigger status of the second button conform to a default rule. The processor is further configured to detect a status of the status control switch if the first trigger status of the first button and the second trigger status of the second button conform to the default rule. The processor is further configured to perform a specific operation on the electronic device in response to the detected status of the status control switch.

### CROSS-REFERENCE TO RELATED APPLICATION

This application is a continuation-in-part application of and claims the priority benefit of U.S. application Ser. No. 14/584,912, filed on Dec. 29, 2014, now pending, which claims the priority benefit of Taiwan application serial no. 103131330, filed on Sep. 11, 2014. The entirety of each of the above-mentioned patent applications is hereby incorporated by reference herein and made a part of this specification.

### FIELD OF THE INVENTION

The invention relates to a control mechanism. More particularly, the invention relates to a control module and a control method of an electronic device.

### DESCRIPTION OF RELATED ART

Since the last half a century, the development in the field of computers has been prosperous. Such development allows a variety of automation equipment (e.g., washing machines, dishwashers, and sweeping robots) to be extensively applied in daily lives. Besides, owing to changes to the household population structure as well as the work style in the modern society, the manual labor devoted to household chores has been gradually replaced by machines. Meanwhile, integrated solutions aiming at coordinating, managing, and controlling various home appliances or equipment, such as lightings, televisions, security systems, air conditioners, audiovisual systems, and so on, now constantly hit the market.

To set up a home automation control system that can be applied to manage various electronic devices, at least one host system may be configured to communicate with such electronic devices, so as to control each electronic device to accomplish corresponding mission/job. However, how to enable a user to conveniently and safely maintain such electronic devices, such as updating important information in each electronic device, is certainly an issue for researchers in this field to work on.

### SUMMARY OF THE INVENTION

The invention is directed to a control module and a control method of an electronic device which allows a user to conveniently and safely maintain the electronic device.

An embodiment of the invention provides a control module of an electronic device. The control module includes a processor, a first button, a second button and a status control switch. The processor is coupled to the first button, the second button and the status control switch. The processor is configured to determine whether a first trigger status of the first button and a second trigger status of the second button conform to a default rule. The processor is further configured to detect a status of the status control switch if the first trigger status of the first button and the second trigger status of the second button conform to the default rule. The processor is further configured to perform a specific operation on the electronic device in response to the detected status of the status control switch.

Another embodiment of the invention provides a control method of an electronic device. The electronic device includes a first button, a second button and a status control switch. The control method comprises: determining whether a first trigger status of the first button and a second trigger status of the second button conform to a default rule; detecting a status of the status control switch if the first trigger status of the first button and the second trigger status of the second button conform to the default rule; and performing a specific operation on the electronic device in response to the detected status of the status control switch.

In view of the above, after the first trigger status of the first button and the second trigger status of the second button are identified as conforming to the default rule, the status of the status control switch is detected and served as the reference for performing the specific operation on the electronic device. Accordingly, the electronic device can be automatically, conveniently and safely maintained.

Several exemplary embodiments accompanied with figures are described in detail below to further describe the invention in details.

### BRIEF DESCRIPTION OF THE DRAWINGS

FIG. 1 is a schematic view illustrating a control system of electronic devices according to an embodiment of the invention.

FIG. 2 is a brief block diagram illustrating a control module according to an embodiment of the invention.

FIG. 3 is a schematic view illustrating a control module according to an embodiment of the invention.

FIG. 4 is a schematic view illustrating a control module according to another embodiment of the invention.

FIG. 5 is a flowchart illustrating a control method of an electronic device according to an embodiment of the invention.

FIG. 6 is a flowchart illustrating a control method of an electronic device according to another embodiment of the invention.

### DETAILED DESCRIPTION OF DISCLOSED EMBODIMENTS

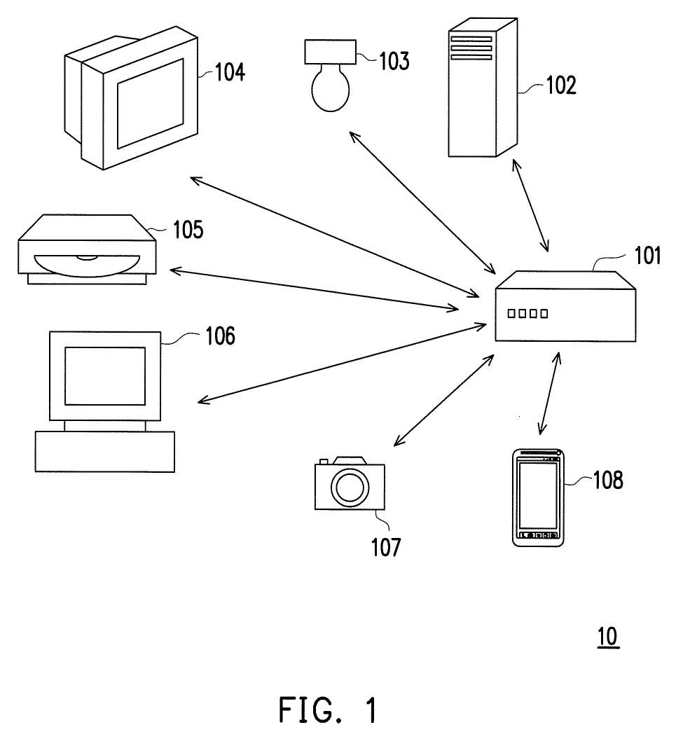

FIG. 1 is a schematic view illustrating a control system of electronic devices according to an embodiment of the invention.

With reference to FIG. 1, the control system 10 includes a server 101 and electronic devices 102-108. The descriptions of the electronic devices 102-108 and the server 101 provided in the following embodiment are merely explanatory and should not be construed as limitations to the invention. In the control system 10, the number of electronic devices should not be limited. For instance, in another embodiment, the number of electronic device may be one or more, and the number of the server may also be one or more. In the following embodiments, the descriptions of the interaction between one electronic device and one server as well as the interaction between one electronic device and other electronic device(s) should not be construed as limitations to the invention. In one embodiment, the control system 10 is also regarded as a home control system.

The server 101 is the central control device of the control system 10. According to the manufacturer's setup, the server 101 may be applied to control, maintain, and manage the electronic devices 102-108 through the operation of a user. In one embodiment, the information communication between the server 101 and the electronic devices 102-108 may be implemented in a wireless manner. In another embodiment, the information communication between the server 101 and the electronic devices 102-108 may also be implemented in a wired manner, e.g., through cables or power lines.

With reference to FIG. 1, each of the electronic devices 102-108 may be a power device, a lighting device, a security device, an air conditioner, an audio-visual entertainment device, and so forth. For instance, given that the electronic device 103 is a lighting device, the electronic device 103 may be correspondingly switched on or off according to the control command issued by the server 101. Given that the electronic device 105 is an audio-visual entertainment device, the electronic device 105 may, according to the control command issued by the server 101, play a multimedia file in a normal manner, a fast-forward manner, or a fast-backward manner, or stop playing the multimedia file. On the other hand, one electronic device may also feedback information to the server 101 for management. In one embodiment, the server 101 may be regarded as a host system of the electronic devices 102-108.

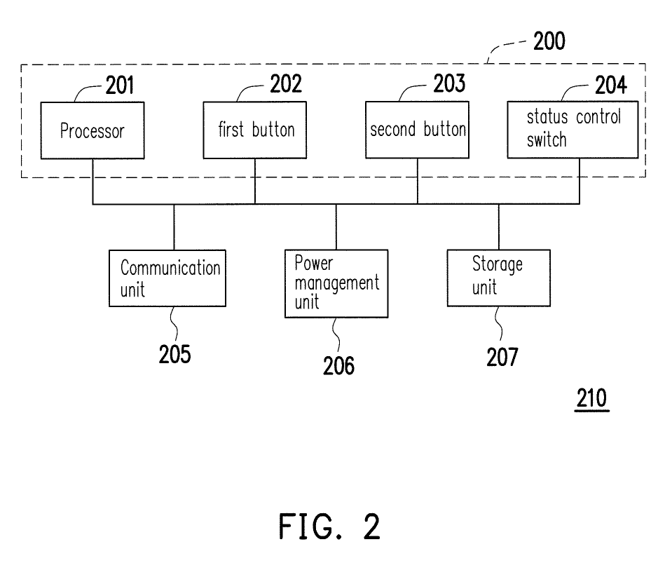

FIG. 2 is a brief block diagram illustrating a control module according to an embodiment of the invention.

With reference to FIG. 2, the electronic device 210 includes a control module 200. The electronic device 210 may be any of the electronic devices 102-108 or a home appliance controller corresponding to at least one of the electronic devices 102-108. If the electronic device 210 is a home appliance controller corresponding to at least one of the electronic devices 102-108, the electronic device 210 may control at least one of the electronic devices 102-108 according to a control command issued by the server 101. For instance, the electronic device 210 may control at least one of the electronic devices 102-108 to execute a function corresponding to the control command. In one embodiment, the electronic device 210 further includes a communication unit 205, a power management unit 206, and a storage unit 207.

In the present embodiment, the control module 200 includes a processor 201. The processor 201 is hardware having a processing capability, and the processor 201 is configured to control the overall operation of the control module 200. The processor 201 may also be configured to control the overall operation of the electronic device 210. In the present embodiment, the processor 201 is, for instance, a central processing unit (CPU), a microprocessor, any other programmable microprocessor, a digital signal processor (DSP), a programmable controller, an application specific integrated circuit (ASIC), a programmable logic device (PLD), or any other similar device.

The communication unit 205 is coupled to the processor 201 for transmitting or receiving data. According to the present embodiment, the communication unit 205 may have a wireless communication circuit (not shown) that supports wireless transmission, such as a global system for mobile communication (GSM), a personal handy-phone system (PHS), a code division multiple access (CDMA) system, a wireless fidelity (WiFi) system, a worldwide interoperability for microwave access (WiMAX) system, a three-generation (3G) wireless communication system, a long term evolution (LTE) system, an infrared transmission system, a Bluetooth communication system, or a combination thereof; however, the invention is not limited thereto.

In another embodiment, the communication unit 205 may have a wired communication circuit (not shown) for transmitting or receiving data through cables. The wired communication circuit may be an optical fiber network circuit and may be connected to the server 101 through an optical fiber interface and optical fibers. In the resultant optical fiber network, information may be transmitted between the server 101 and the electronic device 210. The type and the material of the optical fibers are not limited herein. For instance, the optical fibers may include and should not be limited to single-mode or multi-mode optical fibers. In an embodiment, the optical fibers may be applied together with or be replaced with the power lines.

Taking the electronic device 102, which is assumed to be an air conditioner, as an example of the electronic device 210. The temperature (e.g., 30° C.) at home may be detected by the electronic device 102. The electronic device 102 may transmit the detected temperature information to the server 101 and/or to a mobile phone of the user. In case that the temperature information is transmitted to the server 101, the user may connect a mobile phone to the server 101 to obtain (e.g., download) the temperature information through wired or wireless manner (e.g., via Bluetooth or Wifi). Alternatively, the electronic device 102 may also transmit the temperature information to the mobile phone directly through wired or wireless manner.

If the user wants to adjust the setting of the electronic device 102 (e.g., change the target room temperature), the user may connect his mobile phone to the server 101 through an application program installed in the mobile phone, and then send a control command for controlling the electronic device 102 (e.g., for setting the target room temperature to be 25° C.) to the server 101 through the application program. After receiving the control command, the server 101 sends a control signal to the electronic device 102. According to the control signal, the electronic device 102 may be automatically activated and the target room temperature (e.g., 25° C.) of the electronic device 102 may be set correspondingly.

The power management unit 206 is coupled to the processor 201 for managing the power supply of the electronic device 210. For example, the power management unit 206 may include a power management chip, a power supplier and/or a battery.

The storage unit 207 is coupled to the processor 201. According to the instruction of the processor 201, the storage unit 207 is able to store data temporarily, and the data include data for managing the electronic device 210, data received from the server 101, data to be transmitted to the server 101, or any other data, which should not be contoured as limitations to the invention. Besides, the storage unit 207 may further record some data which takes longer time to be stored according to the instruction of the processor 201, e.g., an identification (ID) of the control module 200 or the electronic device 210, the firmware or software configured to manage the control module 200 or the electronic device 210, etc. According to another embodiment, the storage unit 207 may be included in the processor 201. For example, the storage unit 207 may include a read only memory (ROM), a random access memory (RAM), a flash memory (e.g., SSD) or a combination thereof.

In one embodiment, the ID may be an ID code, a personal identification number (PIN), or any other information. For example, the ID may be used in the data, such as packet, transmitted between the server 101 and the electronic device 210 for identifying the electronic device 210. Besides, the processor 201 may control the control module 200 or the electronic device 210 by executing the firmware or the software.

It is noted that, in the present embodiment, the control module 200 further includes a first button 202, a second button 203 and a status control switch 204. The processor 201 is coupled to the first button 202, the second button 203 and the status control switch 204.

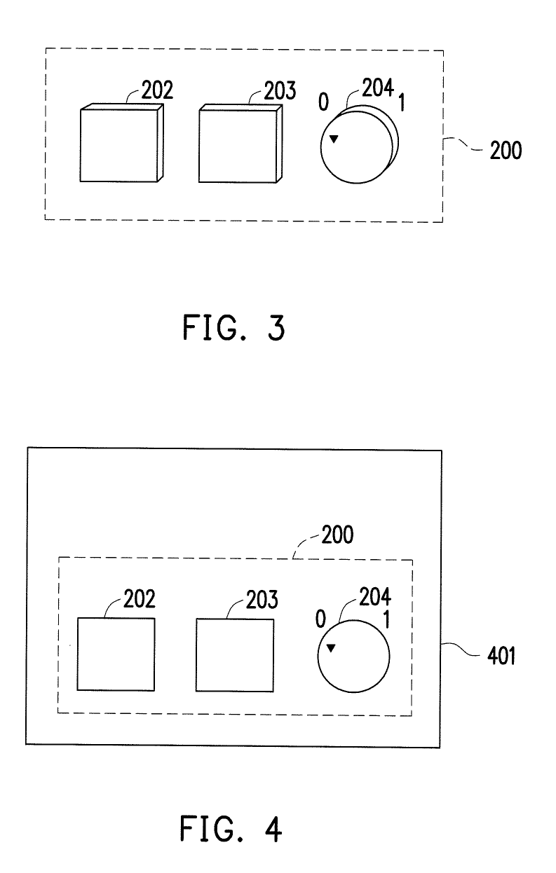

FIG. 3 is a schematic view illustrating a control module according to an embodiment of the invention.

With reference to FIG. 3, in the present embodiment, each of the first button 202 and the second button 203 is a physical button, and the status control switch 204 is a physical switch, such as a physical knob. The user can press the first button 202 to trigger the first button 202 by his finger and then move his finger away from the first button 202 to release the first button 202. Similarly, the user can press the second button 203 to trigger the second button 203 by his finger and then move his finger away from the second button 203 to release the second button 203.

In the present embodiment, the status control switch 204 includes a rotation component, as shown in FIG. 3. The user may rotate the rotation component to change the status of the status control switch 204. For example, through rotating the rotation component, if a rotation position of the rotation component indicated by a pointer is pointed to mark “0”, as shown in FIG. 3, the status of the status control switch 204 is switched to be a status (also known as a first status). Alternatively, through rotating the rotation component, if the rotation position of the rotation component indicated by the pointer is pointed to mark “1”, the status of the status control switch 204 is switched to be another status (also known as a second status). In another embodiment, the mark “0” may correspond to the second status, and the mark “1” may correspond to the first status.

FIG. 4 is a schematic view illustrating a control module according to another embodiment of the invention.

With reference to FIG. 4, in the present embodiment, each of the first button 202 and the second button 203 is a virtual button, and the status control switch 204 is a virtual switch, such as a virtual knob. The first button 202, the second button 203 and the status control switch 204 may be displayed on a screen 401 of the electronic device 210. If the screen 401 is a touch screen, the user can operate the first button 202, the second button 203 and the status control switch 204 by touching the screen 401. For example, the user can use his finger to touch and rotate the displayed rotation component of the status control switch 204, so as to change the rotation position of the rotation component. If the screen 401 is not a touch screen, the user can operate the first button 202, the second button 203 and the status control switch 204 by other means, such a control panel.

It is noted that, in one embodiment, one of the first button 202 and the second button 203 may be physical button, another one of the first button 202 and the second button 203 may be virtual button, and the status control switch 204 may be implemented as virtual switch or physical switch, depending on design choice. Furthermore, in another embodiment, each button and/or the status control switch may also be implemented by different types of component, such as a thermal-sensitive component, a photo-sensitive component, a magnetic-sensitive component, an electric-sensitive component and so on. Furthermore, the configuration position regarding the first button 202, the second button 203 and the status control switch 204 may also be changed and is not limited by FIG. 3 and FIG. 4 above.

In the present embodiment, the processor 201 is configured to determine whether a trigger status (also known as a first trigger status) of the first button 202 and a trigger status (also known as a second trigger status) of the second button 203 conform to a default rule. If the first trigger status of the first button 202 and the second trigger status of the second button 203 conform to the default rule, the processor 201 is further configured to detect a status of the status control switch 204. After the status of the status control switch 204 is detected, the processor 201 is further configured to perform a specific operation on the electronic device 210 in response to the detected status of the status control switch 204.

In one embodiment, the processor 201 determines whether the first button 202 and the second button 203 are both triggered. For example, if the first button 202 and the second button 203 are both pressed, the processor 201 determines that the first button 202 and the second button 203 are both triggered. Otherwise, if at least one of first button 202 and the second button 203 is not pressed (i.e., released), the processor 201 determines that the first button 202 and the second button 203 are not both triggered. In one embodiment, if it is determined that the first button 202 and the second button 203 are not both triggered, the processor 201 determines that the first trigger status of the first button and the second trigger status of the second button do not conform to the default rule.

In one embodiment, if it is determined that the first button 202 and the second button 203 are both triggered, the processor 201 further determines whether at least one of the first button 202 and the second button 203 is released after the first button 202 and the second button 203 are continuously triggered for a default time period. For example, the default time period may be a time range, such as two seconds or longer or shorter. If it is determined that at least one of the first button 202 and the second button 203 is released after the first button 202 and the second button 203 are continuously triggered for the default time period, the processor 201 determines that the first trigger status of the first button 202 and the second trigger status of the second button 203 conform to the default rule.

Otherwise, the processor 201 determines that the first trigger status of the first button 202 and the second trigger status of the second button 203 do not conform to the default rule. For example, if the default time period is two seconds and the user only press the first button 202 and the second button 203 continuously for one second (i.e., the time period that the first button 202 and the second button 203 continuously triggered is shorter than the default time period), then the processor 201 determines that the first trigger status of the first button 202 and the second trigger status of the second button 203 do not conform to the default rule.

In one embodiment, the processor 201 activates a counter in response to that the first button 202 and the second button 203 are both triggered. A counting value of the activated counter is gradually increased with time. Once at least one of the first button 202 and the second button 203 is released, the processor 201 stops the activated counter and obtains the current counting value of the counter. The obtained counting value can represent the time period when first button 202 and the second button 203 are continuously triggered. Accordingly, the processor 201 can determine whether the first button 202 and the second button 203 are continuously triggered for the default time period based on the counting value of the activated counter.

Once the processor 201 determines that the first trigger status of the first button 202 and the second trigger status of the second button 203 conform to the default rule, the processor 201 detects the status of the status control switch 204. For example, the processor 201 may detect the status of the status control switch 204 based on the rotation position of the rotation component. As shown in FIG. 3 or FIG. 4, if the pointer of the rotation component is pointed to the mark “0”, the processor 201 may identify that the status of the status control switch 204 is the first status; and if the pointer of the rotation component is pointed to the mark “1”, the processor 201 may identify that the status of the status control switch 204 is the second status.

The processor 201 can perform a specific operation on the electronic device 210 in response to the detected status of the status control switch 204. For example, the processor 201 may perform a default operation (also known as a first operation) on the electronic device 210 if the detected status of the status control switch 204 is the first status. Alternatively, the processor 201 may perform another default operation (also known as a second operation) on the electronic device 210 if the detected status of the status control switch 204 is the second status. The first operation is different from the second operation.

In one embodiment, in the first operation, the processor 201 receives an ID updating information from the server 101 and updates the ID of the control module 200 or the electronic device 210 based on the received ID updating information. For example, the ID updating information may include a new ID which is assigned to the electronic device 210. The updated ID (i.e., the new ID) may be stored in the storage unit 207 for usage.

In one embodiment, the processor 201 may send a request message to the server 101 for requesting the ID updating information at the beginning of the first operation, and the server 101 may transmit the ID updating information after receiving this request message. For example, the server 101 may check an ID list and select the new ID from the ID list. Then, the server 101 can generated the ID updating information based on the selected ID.

In one embodiment, in the second operation, the processor 201 receives a software/firmware updating information from the server 101 and updates a software or a firmware of the control module 200 or the electronic device 210 based on the received software/firmware updating information. For example, the updated software/firmware may support new function which is different from the old software/firmware or may repair some errors of the old software/firmware. Thereafter, the control module 200 or the electronic device 210 can be operated based on the updated software/firmware. In one embodiment, the software/firmware updating information may include software or firmware which is downloaded from Internet or obtained from other storage medium (e.g., DVD) by the server 101.

In one embodiment, the processor 201 may send a request message to the server 101 for requesting the software/firmware updating info illation at the beginning of the second operation, and the server 101 may transmit the software/firmware updating information after receiving this request message. For example, the server 101 may check a type information and/or a version information of the electronic device 210 according to the request message and then obtain the software/firmware updating information which is suitable for the electronic device 210.

It is noted that, in another embodiment, the number of the switchable status of the status control switch 204 may be more than two, such as three or four. In such case, more operations, such as a third operation or a fourth operation may be performed in response to different status of the status control switch 204 being detected. Furthermore, the specific operation, such as the first operation and/or the second operation, may be replaced with other type of operation, which can be applied to the management of the electronic device 210, depending on design choice.

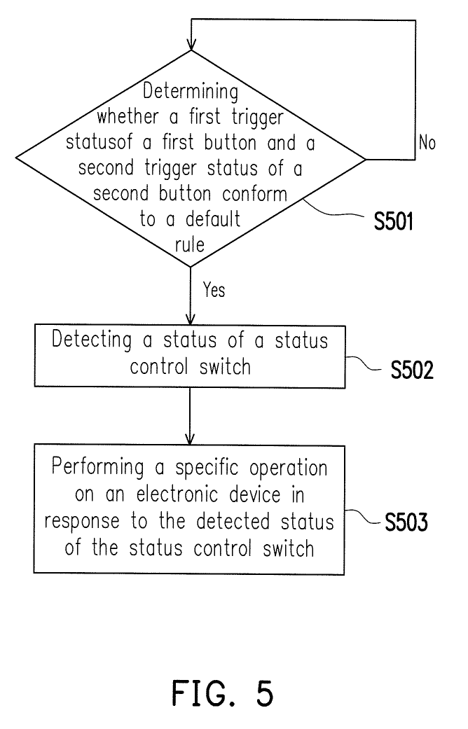

FIG. 5 is a flowchart illustrating a control method of an electronic device according to an embodiment of the invention.

With reference to FIG. 5, in step S501, it is determined whether a first trigger status of a first button and a second trigger status of a second button conform to a default rule. If it is determined that the first trigger status of the first button and the second trigger status of the second button conform to the default rule, in step S502, a status of a status control switch is detected. In step S503, a specific operation is performed on an electronic device in response to the detected status of the status control switch. However, if it is determined that the first trigger status of the first button and the second trigger status of the second button do not conform to the default rule, then the step S501 is repeated.

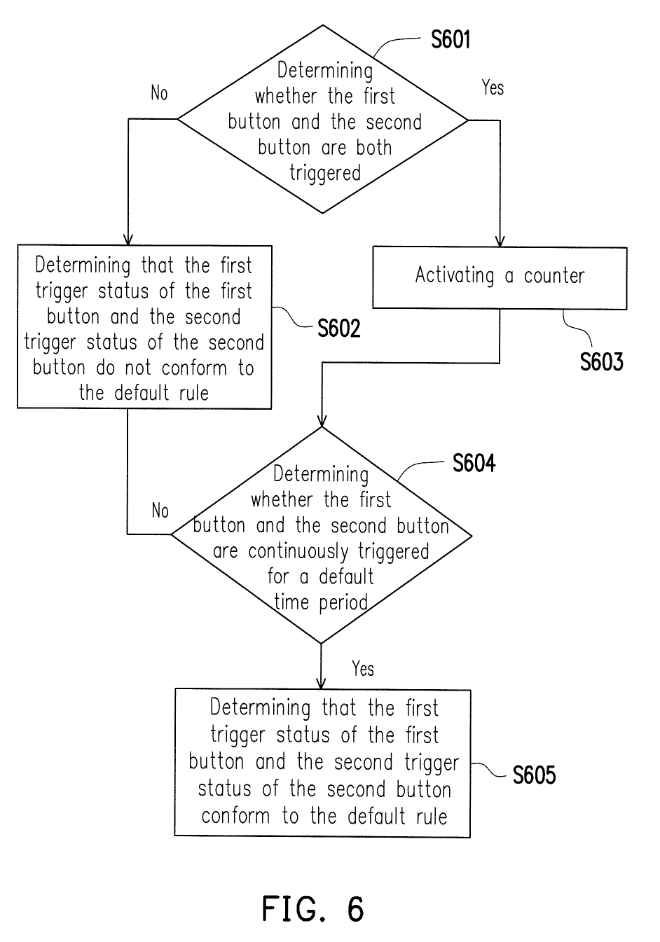

FIG. 6 is a flowchart illustrating a control method of an electronic device according to another embodiment of the invention.

With reference to FIG. 6, in step S601, it is determined whether the first button and the second button are both triggered. If the first button and the second button are not both triggered, in step S602, it is determined that the first trigger status of the first button and the second trigger status of the second button do not conform to the default rule. If the first button and the second button are both triggered, in step S603, a counter is activated. In step S604, it is determined whether the first button and the second button are continuously triggered for a default time period based on a counting value of the activated counter. If the first button and the second button are continuously triggered for the default time period (e.g., a time length that the first button and the second button are both pressed is equal to or longer than the default time period), in step S605, it is determined that the first trigger status of the first button and the second trigger status of the second button conform to the default rule. Otherwise, if the first button and the second button are not continuously triggered for the default time period (e.g., a time length that the first button and the second button are both pressed is shorter than the default time period), step S602 is performed after step S604.

Each step shown in FIG. 5 and FIG. 6 is elaborated above and will not be further explained below. It should be mentioned that each step shown in FIG. 5 and FIG. 6 may be implemented in form of programming codes or circuits; the invention is not thereby limited. Besides, the method illustrated in FIG. 5 and FIG. 6 may be applied with the previous embodiments or may be implemented independently, which should however not be construed as a limitation to the invention.

To sum up, once the first trigger status of the first button and the second trigger status of the second button is determined as conforming to the default rule, the status of the status control switch is detected and served as the reference for performing the specific operation on the electronic device. Accordingly, the electronic device can be automatically and conveniently maintained. Furthermore, by using the trigger statuses of two separate buttons as the double authentication for triggering the specific operation which is performed on the electronic device, the electronic device can be maintained more safely. For example, if there is only single one button configured for triggering a specific operation of the electronic device, the specific operation may be mis-triggered when this single one button is mis-touched.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. An control module of an electronic device, comprising:
a processor;
a first button, coupled to the processor;
a second button, coupled to the processor; and
a status control switch, coupled to the processor,
wherein the processor is configured to determine whether a first trigger status of the first button and a second trigger status of the second button conform to a default rule,
wherein the processor is further configured to detect a status of the status control switch if the first trigger status of the first button and the second trigger status of the second button conform to the default rule,
wherein the processor is further configured to perform a specific operation on the electronic device in response to the detected status of the status control switch.

2. The control module as recited in claim 1, wherein the operation of performing the specific operation on the electronic device in response to the detected status of the status control switch comprises:
performing a first operation on the electronic device if the detected status of the status control switch is a first status; and
performing a second operation on the electronic device if the detected status of the status control switch is a second status,
wherein the first operation is different from the second operation.

3. The control module as recited in claim 2, wherein the first operation comprises:
receiving an identification updating information from a server; and
updating an identification of the electronic device based on the received identification updating information.

4. The control module as recited in claim 3, wherein the first operation further comprises:
sending a request message to the server for requesting the identification updating information.

5. The control module as recited in claim 3, wherein the second operation comprises:
receiving a software/firmware updating information from the server; and
updating a software or a firmware of the electronic device based on the received software/firmware updating information.

6. The control module as recited in claim 5, wherein the second operation further comprises:
sending a request message to the server for requesting the software/firmware updating information.

7. The control module as recited in claim 1, wherein the operation of determining whether the first trigger status of the first button and the second trigger status of the second button conform to the default rule comprises:
determining whether the first button and the second button are both triggered; and
determining that the first trigger status of the first button and the second trigger status of the second button do not conform to the default rule if the first button and the second button are not both triggered.

8. The control module as recited in claim 7, wherein the operation of determining whether the first trigger status of the first button and the second trigger status of the second button conform to the default rule further comprises:
determining whether at least one of the first button and the second button is released after the first button and the second button are continuously triggered for a default time period; and
determining that the first trigger status of the first button and the second trigger status of the second button conform to the default rule if the at least one of the first button and the second button is released after the first button and the second button are continuously triggered for the default time period.

9. The control module as recited in claim 8, wherein the operation of determining whether the first trigger status of the first button and the second trigger status of the second button conform to the default rule further comprises:
activating a counter in response to that the first button and the second button are both triggered; and
determining whether the first button and the second button are continuously triggered for the default time period based on a counting value of the activated counter.

10. The control module as recited in claim 1, wherein the status control switch comprises a rotation component, and the operation of detecting the status of the status control switch comprises:
detecting the status of the status control switch based on a rotation position of the rotation component.

11. An control method of an electronic device, wherein the electronic device comprises a first button, a second button and a status control switch, and the control method comprises:
determining whether a first trigger status of the first button and a second trigger status of the second button conform to a default rule;
detecting a status of the status control switch if the first trigger status of the first button and the second trigger status of the second button conform to the default rule; and
performing a specific operation on the electronic device in response to the detected status of the status control switch.

12. The control method as recited in claim 11, wherein the step of performing the specific operation on the electronic device in response to the detected status of the status control switch comprises:
performing a first operation on the electronic device if the detected status of the status control switch is a first status; and
performing a second operation on the electronic device if the detected status of the status control switch is a second status,
wherein the first operation is different from the second operation.

13. The control method as recited in claim 12, wherein the first operation comprises:
receiving an identification updating information from a server; and
updating an identification of the electronic device based on the received identification updating information.

14. The control method as recited in claim 13, wherein the first operation further comprises:
sending a request message to the server for requesting the identification updating information.

15. The control method as recited in claim 13, wherein the second operation comprises:
receiving a software/firmware updating information from the server; and
updating a software or a firmware of the electronic device based on the received software/fill aware updating information.

16. The control method as recited in claim 15, wherein the second operation further comprises:
sending a request message to the server for requesting the software/firmware updating information.

17. The control method as recited in claim 11, wherein the step of determining whether the first trigger status of the first button and the second trigger status of the second button conform to the default rule comprises:
determining whether the first button and the second button are both triggered; and
determining that the first trigger status of the first button and the second trigger status of the second button do not conform to the default rule if the first button and the second button are not both triggered.

18. The control method as recited in claim 17, wherein the step of determining whether the first trigger status of the first button and the second trigger status of the second button conform to the default rule further comprises:
determining whether at least one of the first button and the second button is released after the first button and the second button are continuously triggered for a default time period; and
determining that the first trigger status of the first button and the second trigger status of the second button conform to the default rule if the at least one of the first button and the second button is released after the first button and the second button are continuously triggered for the default time period.

19. The control method as recited in claim 18, wherein the step of determining whether the first trigger status of the first button and the second trigger status of the second button conform to the default rule further comprises:
activating a counter in response to that the first button and the second button are both triggered; and
determining whether the first button and the second button are continuously triggered for the default time period based on a counting value of the activated counter.

20. The control method as recited in claim 11, wherein the status control switch comprises a rotation component, and the step of detecting the status of the status control switch comprises:
detecting the status of the status control switch based on a rotation position of the rotation component.
